(19) United States
(12) Patent Application Publication
(10) Pub. No.: US 2026/0352575 A1
(43) Pub. Date: Nov. 5, 2026

(54) Assessing Readiness of Organization for Post-Quantum Cryptography

(71) Applicant: DigiCert, Inc., Lehi, UT (US)

(72) Inventors: Jarryd Jermaine Chengalroyen, Cape Town (ZA); Avesta Hojjati, Austin, TX (US)

(73) Assignee: DigiCert, Inc., Lehi, UT (US)

(21) Appl. No.: 19/051,252

(22) Filed: Feb. 12, 2025

(51) Int. Cl. H04L 43/045; H04L 9/40

(52) U.S. Cl. CPC H04L 43/045; H04L 63/1433; H04L 63/20

(57) ABSTRACT

Systems and methods are provided for analyzing and defining the readiness or preparedness of a network infrastructure to transition to Post-Quantum Cryptography (PQC) operation. In one implementation, a method includes a step of collecting information with respect to a current state of a network infrastructure associated with an organization, wherein the collected information is related to compliance of the network infrastructure with PQC standards. The method further includes a step of calculating a PQC readiness score from the collected information. Next, the method includes displaying, on a User Interface (UI), the PQC readiness score and one or more recommended remediation actions for improving the PQC readiness score.

### FIELD OF THE DISCLOSURE

The present disclosure relates generally to network security. More particularly, the present disclosure relates to systems and methods for assessing the readiness or preparedness of a network infrastructure associated with an organization to adopt to Post-Quantum Cryptography (PQC).

### BACKGROUND

A quantum computer, in theory, is configured to perform calculations exponentially faster than modern computers and would therefore be able to break many widely used encryption schemes used today. Although quantum computers have not yet been fully developed, organizations have been warned that these quantum computers, if put in the wrong hands, would make current encryption algorithms obsolete, thereby opening up the door for hackers to cause great disruption to current network systems. In preparation for the day when quantum computing becomes a reality (i.e., Q-day), organizations have begun creating higher levels of encryption techniques that should be much more difficult to crack. This greater level of encryption is known as Post-Quantum Cryptography (PQC) and is sometimes referred to as quantum-proof, quantum-safe, or quantum-resistant. PQC includes cryptographic algorithms (e.g., public-key algorithms) that are currently thought to be secure against attacks by a quantum computer. Furthermore, government agencies (e.g., National Institute of Standards and Technology (NIST), etc.) have released PQC standards for effectively blocking quantum cyber-attacks. However, a present challenge for network operators, administrators, technicians, IT personnel, and other network managing teams, is having a realistic picture of the current state of an organization's network infrastructure in order to understand what types of improvements should be made to protect these network infrastructures.

### BRIEF SUMMARY

The present disclosure relates to systems and methods for determining the Post-Quantum Cryptography (PQC) readiness of an organization's infrastructure. In some embodiments, a method may have steps configured in software or PQC readiness program stored in a memory device or other non-transitory computer-readable media. When configured in software, the method steps may include computing logic and/or instructions that can be executed by a suitable processing component.

According to one implementation, a method includes a step of collecting information with respect to a current state of a network infrastructure associated with an organization, whereby the collected information is related to compliance of the network infrastructure with PQC standards. The method further includes a step of calculating a PQC readiness score from the collected information. The method also includes a step of displaying, on a User Interface (UI), the PQC readiness score and one or more recommended remediation actions for improving the PQC readiness score.

In some embodiments, the network infrastructure may include one or more of Network Elements (NEs), switches, routers, servers, facility security equipment, and organizational cybersecurity policies. The method, in some implementations, may be configured as a PQC readiness program having an assessment engine, a scoring module, and a reporting interface. The step of collecting the information may include obtaining and assessing a) cryptographic algorithms in use in the network infrastructure, b) versions of software and firmware in use in the network infrastructure, and c) compliance parameters with respect to the PQC standards or updated PQC standards. Also, the step of collecting the information may include one or more of a) gathering data associated with input from a network operator upon the execution of an infrastructure survey, and b) automatically gathering data directly from a network domain related to the network infrastructure.

According to some embodiments, the method may further include a step of identifying potential vulnerabilities, susceptibilities, or incompatibilities of the network infrastructure to transition to PQC or resist PQC attacks. The step of calculating the PQC readiness score may include assigning weights to readiness factors of multiple core dimensions assessed with respect to answers provided by a user in response to survey inquiries. The step of calculating the PQC readiness score may further include 1) ranking assessment factors into a plurality of categories including a) infrastructure awareness, b) strategy, c) resource allocation, d) cryptographic inventory and management, and e) adaptability, and 2) computing a sub-score for each category before calculating the PQC readiness score.

The method, in some embodiments, may further include a step of displaying a visual gauge or meter corresponding to the PQC readiness score. The method may also include steps of a) storing historical PQC readiness scores for the network infrastructure over time and b) providing indications of improvements in a current PQC readiness score in response to following the one or more recommended remediation actions. In some embodiments, the method may include steps of a) detecting ongoing changes to PQC standards and newly discovered vulnerabilities in the network infrastructure and b) triggering notifications or alerts when a decrease in an updated PQC readiness score is detected due to the ongoing changes and newly discovered vulnerabilities.

The one or more recommended remediation actions may include a) upgrading software and/or firmware versions to support PQC algorithms, b) rotating cryptographic certificates to quantum-safe algorithms, c) establishing or maturing a Crypto Center of Excellence (CCOE), d) implementing parallel PQC certificate chains alongside existing PKI infrastructure, e) decommissioning and/or disposing of legacy cryptographic equipment and policies, f) closing cryptographic policy gaps that hinder a transition to PQC prevention techniques, g) aligning cryptographic policies with emerging PQC standards set forth by NIST, ANSI X9, and other standards groups, h) replacing cryptographic algorithms susceptible to “harvest now, decrypt later” attacks, i) inspect, label, and/or physically secure Hardware Security Modules (HSMs), key-management servers, backup drives, and cryptographic accelerators, j) install or upgrade physical security equipment in data centers associated with the organization, k) decommissioning, segregating, and/or securely disposing of end-of-life hardware and software components, l) install or upgrade redundancy hardware and software or Disaster Recovery (DR) equipment, m) establish or execute test recovery drills and/or attack testing procedures, and/or n) establish or update personnel screening, testing, and training policies.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a block diagram illustrating a computing system for determining Post-Quantum Cryptography (PQC) readiness, according to various embodiments.

FIG. 2 is a block diagram illustrating the PQC readiness program shown in FIG. 1, according to various embodiments.

FIG. 3 is a block diagram illustrating the assessment engine shown in FIG. 2, according to various embodiments.

FIG. 4 is a diagram illustrating a User Interface (UI) screen for obtaining information about an infrastructure associated with an organization, according to various embodiments.

FIG. 5 is a diagram illustrating a UI screen for displaying a breakdown of an assessment of the infrastructure and remediation suggestions, according to various embodiments.

FIG. 6 is a flow diagram illustrating a method for determining the PQC readiness of an organization's infrastructure, according to various embodiments.

### DETAILED DESCRIPTION

Again, with quantum computing on the horizon, organizations are enhancing or upgrading their network domains and infrastructure (e.g., hardware and software resources) to be able to withstand quantum attacks. The present disclosure relates to systems and methods for assessing the Post-Quantum Cryptography (PQC) readiness of these network infrastructures to give network operators a clear picture of where they stand in terms of preparedness to resist these types of attacks. Traditionally, determining which systems (e.g., applications, devices, etc.) can support PQC algorithms has been a challenge due to the significantly larger memory footprint required by many of these new algorithms.

The systems and methods of the present disclosure are configured to assess the current state of an organization's network, use a valuation system to produce a PQC readiness score, and then provide an interface to a user to display the readiness score and/or other reporting information. In some embodiments, the information obtained for assessing the network status can be received through survey questions and/or through automated network analysis components.

### Computing System

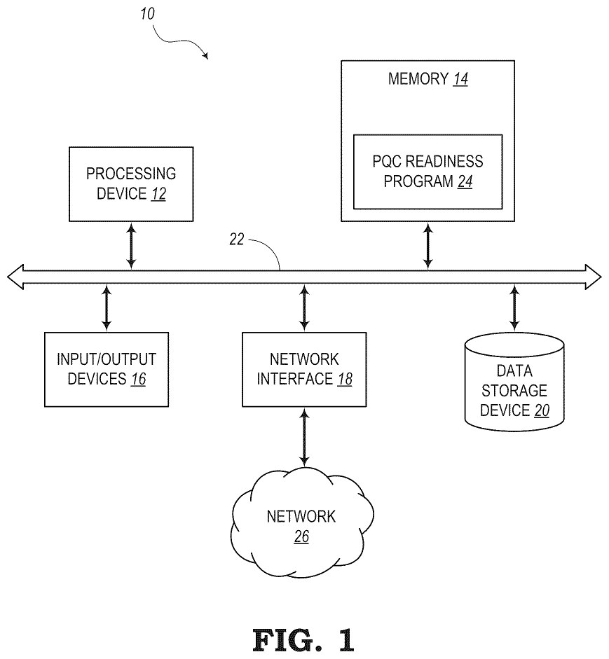

FIG. 1 is a block diagram illustrating an embodiment of a computing system 10 for determining PQC readiness. In some respects, the computing system 10 may be referred to as a PQC readiness meter or preparedness meter that assesses the readiness of an organization's network infrastructure to withstand quantum attacks. A network infrastructure, for example, may refer to any collection of hardware devices (e.g., routers, switches, servers, firewalls, load balancers, access points, transceivers, Ethernet cables, fiber optic cables, etc.) and software components (e.g., operating systems, network management systems, databases, security software, digital certificates, PKI keys, etc.). The components of the network infrastructure are configured to enable communication and data transfer across different segments within a network domain or Local Area Network (LAN). The network infrastructure may also include connectivity and accessibility to a Wide Area Network (WAN), such as the Internet. In addition, the network infrastructure also includes network protocols, security policies, management tools, etc. to maintain secure connectivity and data flow throughout the network.

In some embodiments, the computing system 10 of FIG. 1 may be a component within the network infrastructure. In other embodiments, the computing system 10 may be configured as a remote cloud-based server that is accessible by a management device of the network infrastructure. The computing system 10 is configured to assess the devices, device groups, or policies of the network infrastructure to determine the readiness of the network infrastructure for transitioning to PQC algorithms. The computing system 10, configured for evaluating PQC preparedness, can act as a PQC readiness meter to provide a score or metric indicating how prepared an organization is for adopting PQC algorithms.

As shown in FIG. 1, the computing system 10 may be a digital computer that, in terms of hardware architecture, generally includes a processing device 12, a memory 14, input/output (I/O) devices 16, a network interface 18, and a data storage device 20. It should be appreciated by those of ordinary skill in the art that FIG. 1 depicts the computing system 10 in an oversimplified manner, and a practical embodiment may include additional components and suitably configured processing logic to support known or conventional operating features that are not described in detail herein. The components (12, 14, 16, 18, 20) are communicatively coupled via a local interface 22. The local interface 22 may be, for example, but not limited to one or more buses or other wired or wireless connections, as is known in the art. The local interface 22 may have additional elements, which are omitted for simplicity, such as controllers, buffers (caches), drivers, repeaters, and receivers, among many others, to enable communications. Further, the local interface 22 may include address, control, and/or data connections to enable appropriate communication among the aforementioned components.

The processing device 12 is a hardware device for executing software instructions. The processing device 12 may be any custom made or commercially available processor, a Central Processing Unit (CPU), an auxiliary processor among several processors associated with the computing system 10, a semiconductor-based microprocessor (in the form of a microchip or chipset), or generally any device for executing software instructions. When the computing system 10 is in operation, the processing device 12 is configured to execute software stored within the memory 14, to communicate data to and from the memory 14, and to generally control operations of the computing system 10 pursuant to the software instructions. The I/O devices 16 may be used to receive user input from and/or for providing system output to one or more devices or components.

The network interface 18 may be used to enable the computing system 10 to communicate on a network, such as the Internet. The network interface 18 may include, for example, an Ethernet card or adapter or a Wireless Local Area Network (WLAN) card or adapter. The network interface 18 may include address, control, and/or data connections to enable appropriate communications on the network. A data storage device 20 (e.g., one or more databases, data stores, etc.) may be used to store data. The data storage device 20 may include volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data storage device 20 may incorporate electronic, magnetic, optical, and/or other types of storage media. In one example, the data storage device 20 may be located internal to the computing system 10, such as, for example, an internal hard drive connected to the local interface 22 in the computing system 10. Additionally, in another embodiment, the data storage device 20 may be located externally to the computing system 10 such as, for example, an external hard drive connected to the I/O devices 16 (e.g., SCSI or USB connection). In a further embodiment, the data storage device 20 may be connected to the computing system 10 through a network, such as, for example, a network-attached file server.

The memory 14 may include volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 14 may incorporate electronic, magnetic, optical, and/or other types of storage media. Note that the memory 14 may have a distributed architecture, where various components are situated remotely from one another but can be accessed by the processing device 12. The software in memory 14 may include one or more software programs, each of which includes an ordered listing of executable instructions for implementing logical functions. The software in the memory 14 includes a suitable Operating System (O/S) and one or more programs. The O/S essentially controls the execution of other computer programs, such as the one or more programs, and provides scheduling, input-output control, file and data management, memory management, and communication control and related services. The one or more programs may be configured to implement the various processes, algorithms, methods, techniques, etc. described herein.

The computing system 10 further includes a PQC readiness program 24 that may be implemented in any suitable combination of hardware (e.g., configured in the processing device 12) and/or software/firmware (e.g., configured in the memory 14). The PQC readiness program 24 may be stored in any suitable non-transitory computer-readable media (e.g., the memory 14) and may include computer logic or code having instructions that enable or cause the processing device 12 to perform certain actions as discussed in the present disclosure.

Of note, the general architecture of the computing system 10 can define any device described herein. However, the computing system 10 is merely presented as an example architecture for illustration purposes. Other physical embodiments are contemplated, including virtual machines (VM), software containers, appliances, network devices, and the like.

In an embodiment, the various techniques described herein can be implemented via a cloud service. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. The phrase “Software as a Service” (SaaS) is sometimes used to describe application programs offered through cloud computing. A common shorthand for a provided cloud computing service (or even an aggregation of all existing cloud services) is “the cloud.”

### PQC Readiness Assessment App

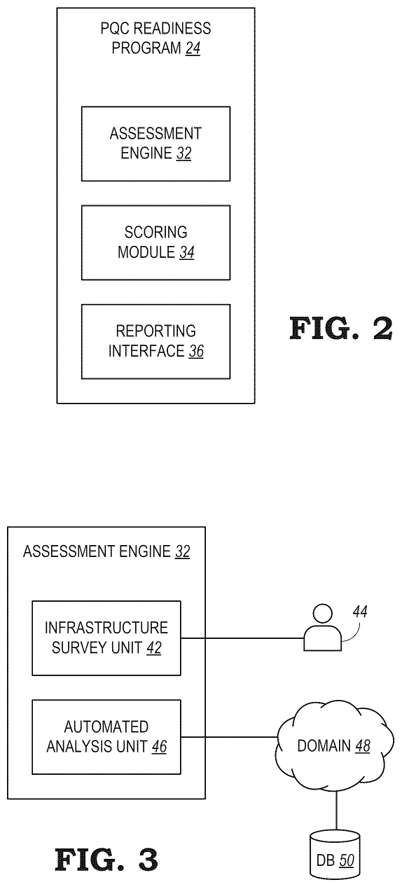

FIG. 2 is a block diagram illustrating an embodiment of the PQC readiness program 24 shown in FIG. 1. In this embodiments, the PQC readiness program 24 includes an assessment engine 32, a scoring module 34, and a reporting interface 36. Generally, the assessment engine 32 is configured to analyze the devices and policies (e.g., hardware and software components) of the network infrastructure to assess its current state. The scoring module 34 is configured to calculate a “PQC readiness score” based on the various criteria obtained by the assessment engine 32. Then, the reporting interface 36 is configured to display the PQC readiness score on a User Interface (UI), dashboard, or the like. In addition to the PQC readiness score, the reporting interface 36 may also provide recommendations for remediation actions to improve the score.

The assessment engine 32 may be configured to evaluate several factors to determine PQC readiness. For example, the assessment engine 32 may determine algorithm usage to identify cryptographic algorithms currently in use and then assess the susceptibility of these algorithms to quantum attacks. The assessment engine 32 may also determine software and/or firmware versions currently in use (e.g., using DigiCert's TrustEdge) and further check if these versions support PQC algorithms and/or are capable of being upgraded. Also, the assessment engine 32 can evaluate network devices and policies of the network infrastructure to detect compliance with current and/or emerging PQC standards, such as those established by NIST. The assessment engine 32 can also perform a vulnerability analysis to identify potential vulnerabilities that may affect the transition to PQC.

The scoring module 34 may include algorithms, calculations, techniques, etc. for computing a PQC readiness score based on the various assessments of the assessment engine 32. The scoring module 34 may utilize weighting techniques for applying weights to each of the various factors, aspects, parameters, variables, etc. detected by the assessment engine 32. Different factors may be weighted according to their significance with respect to a transition to PQC applicability. In some cases, sub-scores may be computed for each of a number of categories and then the sub-scores may be added together to get the total or overall PQC readiness score. In some embodiments, the scoring module 34 may analyze whether certain factors or variables meet certain threshold levels. The overall score can be categorized into different levels of readiness (e.g., low, medium, high) to provide a clear indication of the preparedness of the network infrastructure of the organization.

The reporting interface 36 is configured to present the PQC readiness score and other detailed insights on a User Interface (UI), such as one of the I/O devices 16. A user (e.g., network operator, manager, administrator, network technician, IT staff member, etc.) can view the PQC readiness score on the UI or dashboard to gain an understanding of the current status of the organization's network. The reporting interface 36 may be configured to show the PQC readiness score in an easy-to-understand format. Furthermore, in some embodiments, the reporting interface 36 may be configured to provide a detailed analysis of the breakdown of the score, highlighting areas of strength and areas needing improvement. Also, the reporting interface 36 may be configured to show recommendations for improving the PQC readiness, which may thereby directly result in an increase in the PQC readiness score. The recommendations may include remediation actions that can be taken by network technicians to enhance PQC readiness.

### Assessment Engine

FIG. 3 is a block diagram illustrating an embodiment of the assessment engine 32 shown in FIG. 2. As illustrated, the assessment engine 32 in this embodiment includes an infrastructure survey unit 42, which may receive input from a user 44 (e.g., network operator, technician, network manager, admin, etc.). The infrastructure survey unit 42, for example, may be configured to provide a flow of questions to the user 44 to inquire about the current state of the network infrastructure from a human perspective of one knowledgeable about various network components, data centers, security policies, etc.

Also, the assessment engine 32, according to the embodiment shown in FIG. 3, includes an automated analysis unit 46. The automated analysis unit 46 may be configured to directly and automatically obtain information of a domain 48 associated with the organization and its network infrastructure. In some respects, the domain 48 may include the network infrastructure as described herein.

The automated analysis unit 46 may be configured to obtain information stored in a database 50 (e.g., data storage device 20) accessible through the domain 48. The database 50 may be configured to store data related to various aspects and operations of the network infrastructure. For example, the database 50 may store records of hardware, software, and firmware inventory and upgrades thereof. The database 50 may also store organization policies, security policies, security plans, employee accessibility privileges, etc. The database 50 can also store HR data, employment hierarchy structures, etc. Also, the database 50 may store keys (e.g., PKI keys), digital certificates, etc.

Thus, in addition to the data obtained from the user 44 to gain a human perspective, the assessment engine 32 can also utilize the automated analysis unit 46 to obtain certain information that is accessible by measuring or testing the domain 48 or network infrastructure and/or by retrieving pertinent records from the database 50. From these various sources of information, the assessment engine 32 is configured to determine the current state of the network infrastructure. Information regarding the current state is passed along to the scoring module 34 to enable the scoring module 34 to calculate the PQC readiness score.

### Dashboard of PQC Readiness Assessment App

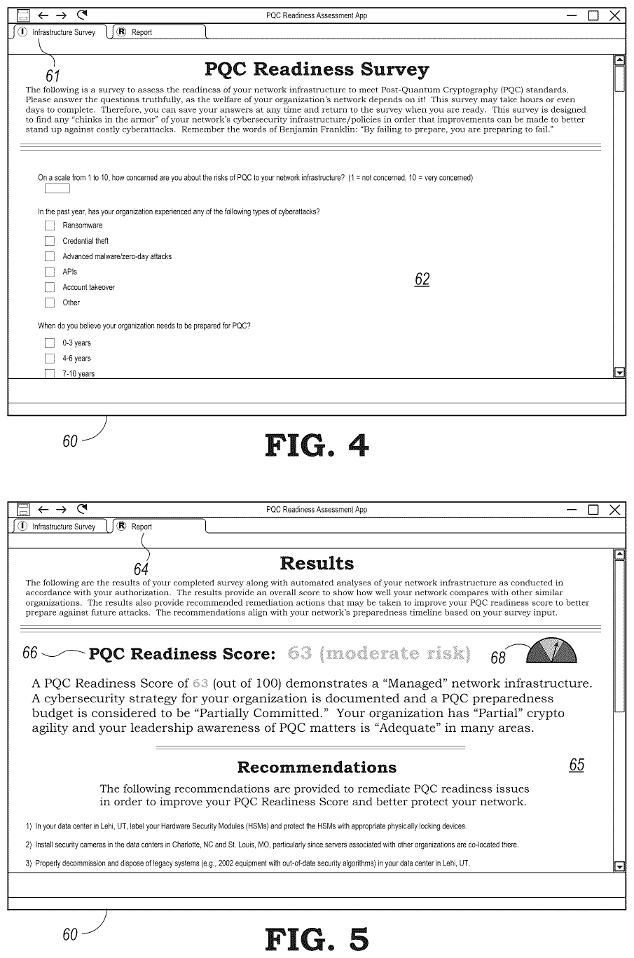

FIG. 4 is a diagram illustrating an embodiment of a dashboard 60 or UI screen for performing a PQC readiness assessment. In FIG. 4, a first tab 61 (i.e., “Infrastructure Survey”) may be selected to display a PQC Readiness Survey screen 62. The PQC readiness survey of the PQC Readiness Survey screen 62 presents a plurality of survey questions to a user (e.g., user 44) to receive input from the perspective of a network manager or other member who has knowledge of the operational functions of the network infrastructure of an organization. The survey may include any number and type of questions or inquiries to gain knowledge of the network infrastructure and an understanding of management's concern regarding any needed improvements of the network infrastructure for meeting PQC standards or at least increasing their readiness score.

The following is list of possible questions or inquiries that may be presented on the PQC Readiness Survey screen 62: “On a scale from 1 to 10, how concerned are you about the risks of PQC to your network infrastructure? (1=not concerned, 10=very concerned)”

“In the past year, has your organization experienced any of the following types of cyberattacks?
a) Ransomware
b) Credential theft
c) Advanced malware/zero-day attacks
d) APIs
e) Account takeover
f) Other”

“When do you believe your organization need to be prepared for PQC?
a) 0-3 years
b) 4-6 years
c) 7-10 years
d) more than 10 years”

“What are the main challenges for your organization to prepare for PQC? (Pick up to three)
a) insufficient resources (time/money)
b) uncertainty about the implications of PQC
c) lack of skilled personnel
d) no clear ownership of the PQC issue
e) algorithms are not done
f) lack of executive-level support
g) inadequate or fragmented management tools
h) others”

“What is your organization's plan for allocating a budget to prepare for PQC?
a) currently allocating a budget
b) plan to allocate a budget in the next six months
c) plan to allocate a budget in the next year
d) plan to allocate a budget after a year
e) no plans to allocate a budget”

“Does your organization currently inventory the types of cryptographic keys used and their characteristics?”

“Does your organization currently understand data retention requirements?”

“Does your organization currently inventory and prioritize cryptographic assets?”

“Does your organization currently have data and cryptographic assets located on-premises or in the cloud?”

“What other steps does your organization currently take to prepare for PQC?”

“Does your organization currently have a strategy for addressing the security implications of quantum computing?
a) currently have a strategy
b) plan to have a strategy in the next six months
c) plan to have a strategy within the next year
d) plan to have a strategy after a year
e) no plans to have a strategy”

“Is your organization knowledgeable of any efforts by industry standards groups to prepare for PQC? Which ones (select all that apply)?
a) ANSI X9's Quantum Risk Study Group
b) National Academy of Sciences Report on Quantum Computing: Progress and Prospects
c) NIST post-quantum cryptography project
d) The Quantum Safe Cryptography Group
e) We are not familiar with any of these groups”

“Does your organization have a centralized enterprise-wide strategy for managing cryptography?
a) yes
b) no
c) not sure”

“How effective has your organization been in updating cryptographic algorithms, parameters, processes, and technologies?”

“How confident are you with respect to having the necessary cryptographic techniques to protect critical information from quantum computing threats?”

“How effectively does your organization deploy and manage cryptographic keys and digital certificates?”

“Are you concerned with your organization's ability to adapt to changes in cryptography (e.g., algorithm deprecation, quantum computing, etc.)?”

“Are you concerned with misconfiguration of keys and certificates?”

“Are you concerned about the increased workload and risk of outages caused by shorter SSL/TLS certificate lifespans?”

“Rate your ability from 1 to 10 (1=low, 10=high) to effectively deploy cryptographic solutions and methods to secure information assets and IT infrastructure.”

“Rate your ability to scale keys and certificates as business needs increase.”

“Rate your ability to attract and retain personnel skilled in PKI and cryptography.”

“Rate your ability to discover and secure every key and certificate.”

“Rate your ability to secure new initiatives, such as hybrid, multi-cloud environment, DevOps, and Zero Trust.”

“Rate your ability to drive enterprise-wide best practices and policies.”

“Rate your ability to detect and respond to certificate/key misuse.”

“Rate your ability to remediate algorithm remediation or breach.”

“Rate your ability to prevent unplanned certificates.”

“Has your organization implemented a Crypto Center of Excellence (CCOE)? If not, is there a plan to implement one?”

“What are the top trends driving the deployment of PKI, keys, certificates, and other secrets?
a) DevOps/DevSecOps (e.g., code, containers, service mesh)
b) Software supply chain security
c) Regulatory/compliance requirements
d) Remote workforce (e.g., VPN, multi-factor authentication)
e) Mobile devices (e.g., BYOD, mobile device management)
f) Internet of Things (IoT) devices
g) Cloud-based services
h) Zero-Trust security strategy
i) Other”

“What are the most important strategic priorities for digital security for your organization?
a) Investing in hiring and retaining qualified personnel
b) Crypto-agility
c) Authenticating and controlling IoT devices
d) Reducing complexity in our IT infrastructure
e) Investing in technologies that enhance the state of digital security
f) Knowing the expiration date of keys and certificates
g) Privileged access management
h) Reducing the risk of unknown keys and certificates in the workplace (e.g., shadow IT)
i) Complying with regulations
j) Other”

“What is your current position within the organization?
a) Executive/VP
b) Director
c) Manager
d) Supervisor
e) Staff/Technician
f) Administrative
g) Consultant
h) Other”

“What best describes your department or team within the organization?
a) DevOps/DevSecOps
b) Identity & Access Management (IAM)
c) IT Security/SEC Ops
d) Networking
e) Risk & Compliance
f) R&D/Engineering
g) IT Operations/Infrastructure
h) Other”

“Is your network equipment housed in a facility or data center that co-locates servers from other organizations?”

“Rate the concern of your organization concerned with ‘harvest now, decrypt later’ attacks?”

“When was the last time someone located, inspected, and labelled any Hardware Security Modules (HSMs), key-management servers, backup drives, and cryptographic accelerators in your facilities?”

“Can you confirm that firmware versions and hardware module support upcoming PQC transition requirements?”

“Are your hardware assets that handle sensitive cryptographic operations tagged, barcoded, and locked down?”

“Does your organization have a hardcopy (e.g., paper, smartcards, hardware tokens, dedicated USB modules, etc.) of certificates and key materials?”

“Does you organization have a formalized procedure for in-person transfer of supervision and security responsibilities within secure locations?”

“Do your data centers have cage security upgrades, dedicated rooms, tamper-resistant racks, closed-circuit TV (CCTV), intrusion-detection sensors, alarms, environmental control systems, etc.?”

“Does your organization have a procedure for decommissioning, removing, and disposing of legacy equipment, end-of-life appliances, and non-compliant systems?”

“Does your organization have adequate redundancy systems and Disaster Recovery (DR) systems?”

“Do you give permission for this application to access your network infrastructure and databases to obtain network operational parameters for further assessing its PQC readiness?”

It should be noted that the above list may include fewer or more survey questions and inquiries. Also, the above list may be altered or modified to inquire about various topics and conditions in a different manner, language, wording, etc. as needed. The list is not meant to be limiting and is intended to convey the general inquiries to uncover information leading to a realistic picture of the network infrastructure.

Upon receiving input from the user 44 (in addition to data obtained by automatically searching the domain 48 and database 50 associated with the network infrastructure), the assessment engine 32 may be configured to perform various analysis, such as by using Machine Learning (ML) techniques, to get a clear picture of the state of the organization's network. Additional analyses and computation can be executed to assess the state of the network. From the final analysis conclusions, the scoring module 34 can calculate a readiness score and determine appropriate recommendations to the organization in order to assist with increasing their readiness score, overcoming shortcomings, upgrading equipment and firmware, etc. to improve the network's level of preparedness for PQC.

FIG. 5 is a diagram illustrating an embodiment of the dashboard 60 or UI screen for performing the PQC readiness assessment. In FIG. 5, a second tab 64 (i.e., “Report”) may be selected to display a Results screen 65. The Results screen 65, for instance, may include a PQC readiness score 66. In some embodiments, the PQC readiness score 66 may be numerical value between 1 and 100. As illustrated, the score is shown in this example is “63,” which can be interpreted as indicating a “moderate risk” with respect to PQC readiness. Also, the Results screen 65 may include a visual gauge 68 (e.g., meter, dial, etc.) showing the score and how it might compare with the scores of other organizations.

In addition, the Results screen 65 may further include one or more Recommendations that are intended to guide the user (e.g., network operator) to take one or more remediation actions for improving their score and better protecting their network. The Recommendation may be listed in any suitable order, such as from most important to least important. For example, the most important remediation actions may be designed to improve the readiness score by a greater extent.

### Process for Determining PQC Readiness

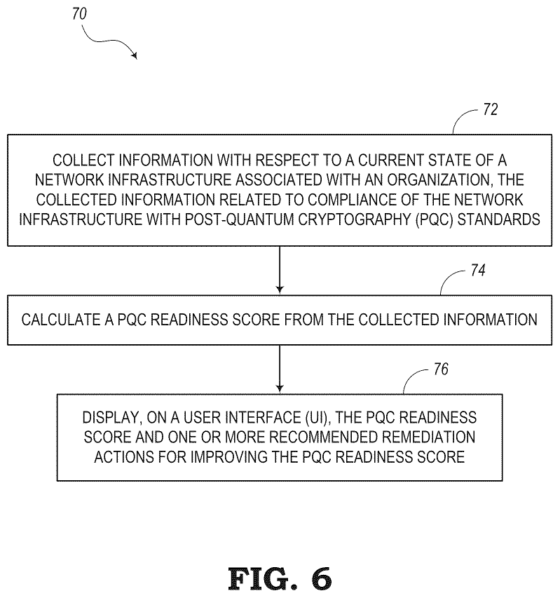

FIG. 6 is a flow diagram illustrating an embodiment of a method 70 for determining the PQC readiness of an organization's infrastructure. In some embodiments, the method 70 may be configured in software (e.g., the PQC readiness program 24) in a memory device (e.g., the memory 14) or other non-transitory computer-readable media. When configured in software, the method 70 may include computing logic and/or instructions that can be executed by a suitable processing component (e.g., the processing device 12).

As shown in FIG. 6, the method 70 includes a step of collecting information with respect to a current state of a network infrastructure associated with an organization, as indicated in block 72, whereby the collected information is related to compliance of the network infrastructure with Post-Quantum Cryptography (PQC) standards. The method 70 further includes a step of calculating a PQC readiness score from the collected information, as indicated in block 74. The method 70 also includes a step of displaying, on a User Interface (UI), the PQC readiness score and one or more recommended remediation actions for improving the PQC readiness score, as indicated in block 76.

In some embodiments, the network infrastructure may include one or more of Network Elements (NEs), switches, routers, servers, facility security equipment, and organizational cybersecurity policies. The method 70, in some implementations, may be configured as a PQC readiness program having an assessment engine, a scoring module, and a reporting interface. The step of collecting the information (block 72) may include obtaining and assessing a) cryptographic algorithms in use in the network infrastructure, b) versions of software and firmware in use in the network infrastructure, and c) compliance parameters with respect to the PQC standards or updated PQC standards. Also, the step of collecting the information (block 72) may include one or more of a) gathering data associated with input from a network operator upon the execution of an infrastructure survey, and b) automatically gathering data directly from a network domain related to the network infrastructure.

According to some embodiments, the method 70 may further include a step of identifying potential vulnerabilities, susceptibilities, or incompatibilities of the network infrastructure to transition to PQC or resist PQC attacks. The step of calculating the PQC readiness score (block 74) may include assigning weights to readiness factors of multiple core dimensions assessed with respect to answers provided by a user in response to survey inquiries. The step of calculating the PQC readiness score (block 74) may further include 1) ranking assessment factors into a plurality of categories including a) infrastructure awareness, b) strategy, c) resource allocation, d) cryptographic inventory and management, and e) adaptability, and 2) computing a sub-score for each category before calculating the PQC readiness score.

The method 70, in some embodiments, may further include a step of displaying a visual gauge or meter corresponding to the PQC readiness score. The method 70 may also include steps of a) storing historical PQC readiness scores for the network infrastructure over time and b) providing indications of improvements in a current PQC readiness score in response to following the one or more recommended remediation actions. In some embodiments, the method 70 may include steps of a) detecting ongoing changes to PQC standards and newly discovered vulnerabilities in the network infrastructure and b) triggering notifications or alerts when a decrease in an updated PQC readiness score is detected due to the ongoing changes and newly discovered vulnerabilities.

The one or more recommended remediation actions (block 76) may include a) upgrading software and/or firmware versions to support PQC algorithms, b) rotating cryptographic certificates to quantum-safe algorithms, c) establishing or maturing a Crypto Center of Excellence (CCOE), d) implementing parallel PQC certificate chains alongside existing PKI infrastructure, e) decommissioning and/or disposing of legacy cryptographic equipment and policies, f) closing cryptographic policy gaps that hinder a transition to PQC prevention techniques, g) aligning cryptographic policies with emerging PQC standards set forth by NIST, ANSI X9, and other standards groups, h) replacing cryptographic algorithms susceptible to “harvest now, decrypt later” attacks, i) inspect, label, and/or physically secure Hardware Security Modules (HSMs), key-management servers, backup drives, and cryptographic accelerators, j) install or upgrade physical security equipment in data centers associated with the organization, k) decommissioning, segregating, and/or securely disposing of end-of-life hardware and software components, l) install or upgrade redundancy hardware and software or Disaster Recovery (DR) equipment, m) establish or execute test recovery drills and/or attack testing procedures, and/or n) establish or update personnel screening, testing, and training policies.

### Further Considerations

The concepts of PQC readiness/preparedness may be implemented in any suitable system, method, dashboard, meter construction, etc. for communicating the current state of the network infrastructure to a user. The following is an embodiment of a step-by-step procedure of how to transform survey data and insights from a survey report into practical PQC readiness implementations. The embodiment may essentially take key indicators of post-quantum readiness from the survey or report and translate them into a composite score, thereby allowing the systems and methods of the present disclosure to benchmark an organization's overall preparedness for PQC.

### Step 1: Identify the Core Dimensions of PQC Readiness

Based on survey results, five core dimensions emerge regarding an organization's PQC readiness:
A. Awareness & Timeline Urgency—i) Leadership's and team's awareness of the quantum threat (“very worried,” “somewhat aware,” etc.), ii) Stated timeline for needing to be PQC-ready (e.g., “less than 5 years,” “5-7 years,” “more than 10 years”), iii) Familiarity with industry standards groups (NIST, ANSI X9, etc.)
B. Strategy & Governance—i) Existence of a formal PQC readiness strategy, ii) Clarity of ownership (i.e., who is responsible for PQC efforts), iii) Involvement/awareness of executive leadership
C. Resource Allocation & Budget—i) Percentage of security budget dedicated to PQC, ii) Availability of skilled personnel, iii) Presence or maturity of a Crypto Center of Excellence (CCOE)
D. Cryptographic Inventory & Management—i) Existence of a centralized, enterprise-wide crypto-management strategy, ii) Inventory of cryptographic assets (keys, certificates), iii) Knowledge of where cryptographic assets (on-prem vs. cloud) reside, iv) Ability to update or rotate algorithms in a timely manner
E. Crypto Agility & Technical Capabilities—i) Organization's ability to adapt to changes in cryptography (e.g., NIST algorithm deprecations, new PQC algorithms), ii) Confidence in having cryptographic techniques to protect against quantum threats (“very effective” vs. “less effective”), iii) Timeliness of updating algorithms, parameters, and processes

### Step 2: Select Specific Survey Questions/Data Points

From the report's tables and figures, pinpoint the questions most relevant to each core dimension. Here is a condensed mapping:
A. Awareness & Timeline Urgency—i) “When do you believe your organization needs to be prepared for PQC?,” ii) “What is your level of concern about not being prepared (1-10 scale)?,” iii) “What is your concern over ‘harvest now, decrypt later’ attacks (1-10 scale)?,” iv) “What is your familiarity with industry standards groups?”
B. Strategy & Governance—i) “Does your organization have a strategy for addressing the security implications of quantum computing?,” ii) “How aware is your organization's leadership about the security implications of quantum computing?,” iii) “What are the main challenges to preparing for PQC? (selecting “no clear ownership,” “lack of executive support”)”
C. Resource Allocation & Budget—i) “Is your organization allocating any budget to prepare for post quantum computing?,” ii) “Has your organization implemented a Crypto Center of Excellence (CCOE)?,” iii) “What are the main challenges . . . ? (selecting “lack of skilled personnel,” “insufficient resources”)”
D. Cryptographic Inventory & Management—i) “Does your organization have a centralized enterprise-wide strategy for managing cryptography?,” ii) “What steps is your organization taking to prepare for post-quantum cryptography? (looking for “inventory and prioritize cryptographic assets,” “inventory the types of cryptographic keys used,” etc.),” iii) “Does your organization know exactly how many keys and certificates it has?,” iv) “What are your concerns about misconfiguration and ability to adapt to changes in cryptography?”
E. Crypto Agility & Technical Capabilities—i) “What is your effectiveness at updating cryptographic algorithms, parameters, processes, etc. (1-10 scale)?,” ii) “What is your confidence in having the necessary cryptographic techniques to protect critical information (1-10 scale)?,” iii) “What are your abilities to detect and respond to certificate misuse, remediate algorithm breaches, scale certificates, etc. ?”

### Step 3: Define a Scoring Approach

A typical scoring method involves assigning point values to each question or response. For each dimension, you can total up points, then roll them into an overall weighted average that becomes the “PQC Readiness Meter.” Below is an illustrative approach:

### A. Convert Responses to a 0-10 or 0 -100 Scale

For single-choice items (e.g., “Does your organization have a strategy for addressing QC?”), you might give:
   10 points=“Yes, we currently have a strategy”
   5 points=“Plan to have in the next 6 months”
   3 points=“Plan to have in the next year”
   0 points=“No plans”
For multi-level scales (1-10 for confidence/effectiveness questions), you can use the actual numeric average or re-map them to 0-10.

### B. Assign Weights to Dimensions

For instance, you might decide on the following dimension weights:
Awareness & Timeline Urgency: 10%
Strategy & Governance: 20%
Resource Allocation & Budget: 20%
Cryptographic Inventory & Management: 25%
Crypto Agility & Technical Capabilities: 25%

These weights reflect how critical each dimension is in ensuring quantum-safe readiness. You can adjust them based on organizational priorities.

### C. Calculate Sub-Scores for Each Dimension

Example: Strategy sub-score=average of (Strategy question scores)*dimension weight.

### D. Combine Sub-scores Into a Final Index

PQC Readiness Score=(Σ dimension sub-score)
Depending on your preference, the result can be expressed as a numeric value (0-100) or a 1-5 level rating (e.g., “Ad Hoc,” “Developing,” “Defined,” “Managed,” “Optimized”).

### Example Calculation for a Hypothetical Organization

### A. Awareness & Timeline Urgency (Weight 10%)

They say they need to be PQC-ready in <5 years (showing high urgency)=10/10
They are “very concerned” (9 or 10 on a 10-point scale)=10/10
Score average=(10+10)/2=10→Weighted sub-score=10*0.10=1.0

### B. Strategy & Governance (Weight 20%)

They have a strategy in place now=10/10
Their leadership is “very aware”=10/10
Score average=(10+10)/2=10→Weighted sub-score=10*0.20=2.0

### C. Resource Allocation & Budget (Weight 20%)

They are “currently allocating budget” for PQC=10/10
They have a mature CCOE=10/10
Score average=(10+10)/2=10→Weighted sub-score=10*0.20=2.0

### D. Cryptographic Inventory & Management (Weight 25%)

They do maintain a centralized enterprise-wide crypto strategy=10/10
They do inventory cryptographic assets=10/10
They do know exactly how many keys/certs exist (reverse-coded question)→10/10
Score average=(10+10+10)/3=10→Weighted sub-score=10*0.25=2.5

### E. Crypto Agility & Technical Capabilities (Weight 25%)

Their rating on “effectiveness to update algorithms” is 7 out of 10
Their rating on “confidence to protect from quantum threats” is 8 out of 10
Score average=(7+8)/2=7.5→Weighted sub-score=7.5*0.25=1.875

Overall PQC Readiness Meter=2.0+2.0+2.5+1.875+1.0=9.375 out of 10 (or 93.75 out of 100)

In reality, few organizations would reach that near-perfect score. More realistic distribution helps you categorize organizations into levels (e.g., 0-3=“Lagging,” 4-6=“Developing,” 7-8=“Accelerating,” 9-1=“Leading”).

### Step 4: Develop Readiness Categories

To make the meter actionable, many organizations use a maturity model approach. For example:

A. Level 1: Not Ready/Ad Hoc (Score ~0 -30 on a 0-100 scale)
No formal PQC strategy, no budget, limited or no cryptographic inventory.

### B. Level 2: Developing (Score ~31-50)

Strategy in early phases, limited budget, some partial inventories, partial awareness.

### C. Level 3: Managed (Score ~51-70)

Strategy is documented, budget is partially committed, partial crypto agility, some awareness in leadership.

### D. Level 4: Accelerating (Score ~71-85)

Organization invests in real budget and resources, thorough cryptographic management, well-developed CCOE, good awareness.

### E. Level 5: Quantum-Ready (Score ~86-100)

Comprehensive strategy, strong crypto-management, robust agility, top-level leadership engagement, full inventory, advanced training & staffing.

### Step 5: Incorporate Benchmarking or “High Performers” Insights

The survey results may also highlight that “high performing organizations” (those who self-assessed as effective in mitigating risks) exhibit different behaviors:
They more urgently expect the quantum threat (<5 years).
They are significantly more likely to have a PQC strategy already or in the next 6 months.
They have a greater likelihood of a centralized crypto-management program.

If you wish to go further, you can refine your readiness meter by benchmarking against the “high performer” subset from the survey data—for instance, determining how your organization's sub-scores compare to that group's average in each dimension.

### Step 6: Presenting the PQC Readiness Meter

In many security dashboards or executive reports, the final index is presented as a single gauge or meter with color bands:
Red=0-30% (Immediate Risk)
Yellow=31-70% (Moderate Risk)
Green=71-100% (On Track/Leading)

Underneath the main gauge, each dimension (Strategy, Budget, Crypto Management, etc.) can be shown as sub-bars, giving clarity regarding where improvements are most needed.

### Putting It All Together

In summary, building a PQC Readiness Meter from the survey results may involve:
1. Selecting Key Indicators: From the questions/metrics around PQC timelines, current strategies, cryptographic management, resource allocation, and awareness.
2. Scoring Responses: Converting each response category or scale into numeric values.
3. Weighting Dimensions: Deciding how much each dimension (e.g., Strategy vs. Resource Allocation) contributes to overall readiness.
4. Calculating a Composite Score: Summing up each dimension's sub-score to get a 0-100 or 1-10 “readiness” rating.
5. Defining Readiness Tiers: Translating the numeric score into meaningful maturity categories, which helps stakeholders understand where their organization stands and what next steps are needed.

This approach yields a practical, data-driven “meter” that not only shows your organization's level of PQC readiness but also highlights which areas of PQC preparation—strategy, budget, cryptographic agility, or leadership awareness—most urgently need attention.

### Remediation Actions

The following is a list of PQC remediation options with an emphasis on physical, hands-on, or operational actions you can take. The issues described below may be related to a greater depth of understanding than the survey questions described above can obtain. In some cases, the survey questions may follow a flowchart-type path, where the answer to one question may lead to one or more follow-up questions. While some strategic elements remain unavoidable (because PQC readiness spans policy and technical upgrades), these recommendations focus on concrete measures you can enact within your physical IT environment and processes.

### 1. Physical Cryptography Audits & Asset Tagging (Inventory Awareness)

### A. On-Site Equipment & HSM Inspection

Conduct physical walkthroughs of data centers to locate, inspect, and label any Hardware Security Modules (HSMs), key-management servers, backup drives, and cryptographic accelerators.
Confirm that firmware versions and hardware modules support upcoming PQC transition requirements.

### B. Hardware Asset Tagging

Tag and barcode all devices that handle sensitive cryptographic operations—e.g., physical servers, secure enclaves, vaults, and air-gapped machines.
Record PQC readiness details (firmware level, supported algorithms, estimated end-of-life) on each asset tag.

### C. Secure Storage & Backup Repositories

Physically group backups and archives that contain particularly sensitive data.
Ensure their locations are locked down, monitored, and controlled with strict physical access procedures.

### 2. Physical Handling of Keys & Certificates

### A. Hardcopy Certificates & Key Material

If you still store master keys or root certificates on paper or physical tokens (such as smartcards, hardware tokens, or dedicated USB modules), review current physical protections (e.g., locked safe, sealed tamper-evident bags).
Retire or destroy any outdated backups (using shred/burn/incineration services certified for secure disposal).

### B. Secure Key Courier Processes

For environments requiring offline key generation and distribution, establish secure courier protocols.
Use tamper-evident packaging when sending cryptographic tokens or media between sites.
Maintain chain-of-custody logs to track any handover of physical key material.

### C. Physical Ceremony for Key Rotation

For high-trust environments, conduct periodic “key ceremonies” in physically secured rooms. This may include a formalized procedure for commissioning or decommissioning security equipment and personnel.
Verify each step in-person (with designated roles like Key Custodian, Security Officer) to guarantee the integrity of the process.

### 3. Data Center & Cage Security Upgrades

### A. Dedicated Cages or Rooms

If quantum-safe hardware or sensitive cryptographic operations run in a shared colocation facility, isolate them in a dedicated locked cage, room, or vault.
Utilize closed-circuit TV (CCTV), dual-factor access (badge +biometric), and secure logging of all entrants.

### B. Tamper-Resistant Racks

Use server racks with tamper-evident seals, intrusion-detection sensors, or locks that trigger alerts if opened without authorization.
Inspect cables and interfaces for possible hardware keyloggers or sniffers.

### C. Temperature & Environmental Controls

For quantum-safe hardware accelerators or HPC (high-performance computing) systems, verify that data center cooling and power meet manufacturer specs (voltage, temperature, humidity).
Avoid environmental fluctuations that degrade hardware performance or cause unexpected reboots/interruptions that can break cryptographic processes.

### 4. Physical Removal or Replacement of Legacy Crypto Gear

### A. Identify End-of-Life (EOL) Appliances

Physically isolate out-of-support HSMs, network appliances, or encryption accelerators that cannot be upgraded to PQC-friendly firmware.
Plan a phased removal and disposal schedule.

### B. Secure Disposal & Decommissioning

Follow standards such as NIST SP 800-88 for media sanitization.
Use on-site shredders or specialized disposal services to destroy devices containing private keys, certificates, or sensitive data that might be targeted in a “harvest now, decrypt later” scenario.

### C. Physical Segregation of Non-Compliant Systems

If immediate decommission is not possible (due to legacy dependencies), physically segment those systems in a separate, tightly controlled network zone with restricted access points, pending final retirement.

### 5. Facility-Level Security & Redundancies

### A. Redundant PQC Key-Generation Sites

Maintain at least two physically distant locations for key generation and cryptographic operations (e.g., primary data center +disaster recovery site).
Each site should have identical or compatible PQC-ready hardware and hardened physical security.

### B. Disaster Recovery (DR) Drills

Physically verify that DR facilities stock enough PQC-capable equipment.
Regularly drill staff on failover procedures, including physically transporting secure tokens or rekeying hardware when switching sites.

### C. Emergency Power & Cooling

Some PQC or cryptographic hardware can be sensitive to power fluctuations.
Ensure on-site generators, battery backups, and adequate cooling so cryptographic processes remain stable if main power fails.

### 6. Personnel Screening & Training (Hands-On)

### A. In-Person Workshops & Labs

Conduct classroom-style sessions where security teams physically handle PQC-ready hardware, learn how to configure post-quantum algorithms, and perform key rotations.
Run hands-on labs demonstrating the lifecycle of next-gen certificates and how to physically secure them.

### B. Enhanced Background Checks

Extend background checks and vetting to all personnel with physical access to cryptographic equipment (including contractors, maintenance, cleaning crews).
Implement dual-or triple-person rules for especially sensitive operations (e.g., loading keys into an HSM).

### C. Physical Access Revocation Processes

Tie all hardware access badges to HR records so that when employees or contractors exit the organization, their physical access to PQC-critical zones is revoked immediately.
Perform periodic audits of badge access logs for anomalies.

### 7. Test Physical Contingencies for “Harvest Now, Decrypt Later”

### A. Secure Archival Vaults

Transfer especially sensitive historical data—potentially valuable in the long term—to physically hardened vaults.
Encrypt it using stronger interim algorithms or hybrid post-quantum algorithms and keep offline copies where possible.

### B. Physical Air Gaps for Long-Lived Data

For extremely high-value information (classified data, industrial IP), maintain an offline repository disconnected from any network.
Require in-person checks, multiple signoffs, and physically separate hardware for accessing or updating the data.

### C. Espionage Countermeasures

If you suspect advanced adversaries might install hidden cameras, keyloggers, or radio sniffers near cryptographic equipment, periodically sweep the facility for covert devices or electromagnetic leaks (TEMPEST).

### 8. Secure Physical Handling During PQC Algorithm Deployments

### A. Firmware & Algorithm Updates on Secure Media

Deliver PQC library or firmware updates only via trusted USB drives or DVDs, stored in tamper-evident bags.
Use sealed envelopes or double-sealed containers for transporting the media to the data center.

### B. Secure Boot & BIOS Locks

Physically lock server BIOS/UEFI settings and enable secure boot features to prevent unauthorized re-flashing of firmware with malicious code.
Keep master BIOS/UEFI passwords in a secure safe, accessible only to authorized personnel.

### C. Side-Channel Attack Protections

Implement shielding or acoustic isolation if your PQC hardware might be vulnerable to side-channel attacks (power analysis, electromagnetic leaks, etc.).
Consult hardware vendors for recommended physical shielding or specialized racks to mitigate side-channel risks.

### 9. Improve On-Prem & Colocation Agreements

### A. Physical Security Clauses in Contracts

If you host servers in colocation or shared data centers, negotiate clear SLAs around physical security (locking cabinets, surveillance coverage, biometric access, etc.).
Require immediate notification and remedy if anyone (including data center staff) accesses your racks without explicit permission.

### B. Regular On-Site Assessments

Conduct unannounced spot checks to verify that the colocation provider follows agreed-upon security protocols (visitor logs, escorted visits, etc.).
Document any discrepancies and request corrective action.
   C. Segregation from Other Tenants
Physically separate your cryptographic hardware from other tenants'racks.
Request dedicated hallways or locked cages so there is no chance of “accidental” tampering by neighboring tenants or their contractors.

### 10.Establish Routine Physical Drills & Testing

### A. Hands-On Incident Response Exercises

Simulate a security breach where adversaries try to physically tamper with cryptographic devices or steal key material.
Test how quickly your team can detect the intrusion and relocate or safeguard the hardware.

### B. Periodic Tamper-Evident Seal Inspections

Place seals on rack doors, panels, HSM modules, and even USB ports.
Conduct random inspections to confirm no seals are broken or suspiciously replaced.

### C. Tabletop Drills for PQC-Specific Events

Scenario: A new quantum breakthrough is announced, forcing emergency rekeying.
Practice physically securing the site, retrieving new key materials, and distributing them per your post-quantum plan.

### Conclusion Regarding Remediation Actions

Even in a digitally-focused domain like cryptography, physical controls remain critical—especially when preparing for the rising threats of quantum computing. By putting tangible, hands-on measures in place (e.g., hardware inspections, secure key handling, data center lockdowns, physical redundancy) and regularly testing them, organizations build a more resilient and quantum-safe environment.

### PQC Readiness Anecdote

A global logistics company, Company XYZ, operates a vast IoT fleet, including smart delivery drones, vehicle tracking systems, and sensors. As quantum computing rises, the company recognizes the need to future-proof its infrastructure.

Company XYZ evaluates their devices using the PQC readiness meter described herein. The assessment engine evaluated factors such as: 80% of the devices were using elliptic curve cryptography (ECC), which is vulnerable to quantum attacks. The firmware analysis showed that only 60% of devices could support PQC algorithms with an upgrade. Policies governing certificate issuance were also found to be non-compliant with NIST's (NIST=National Institute of Standards and Technology) PQC draft guidelines. Also, a sister certificate chain using PQC was not set up-this parallel chain could run alongside the existing classical PKI infrastructure, allowing for gradual migration and devices identified as PQC-compatible could be configured to automatically renew their certificates from the PQC chain during the next scheduled renewal cycle.

Based on the assessment engine, the scoring algorithm assigned an initial readiness score of 58/100. The detailed report suggests prioritizing high-risk device groups, like drones carrying sensitive data, for immediate PQC certificate enrollment. Also, it suggests setting up the sister certificate chain. A few months later, after firmware upgrades and policy updates and setting up the sister chain, it was found that 82.5% of devices could successfully be renewed with PQC certificates, boosting their readiness score to 88/100. Over time, it can suggest changes, recalculate scores, and see that their changes have resulted in better preparedness/readiness.

### Conclusion

Technical Problem and Solution: Existing approaches to post-quantum cryptography (PQC) readiness often rely on ad hoc or paper-based assessments that provide only a static snapshot of risk. In contrast, the embodiments described herein employ a specialized PQC readiness program, executed by one or more processing devices, to address the technological challenge of continuously analyzing and preparing a network infrastructure against quantum-based threats. This program integrates software-and hardware-level data collection—such as firmware versions, cryptographic usage, and active cryptographic modules—to dynamically measure an organization's preparedness for PQC. By correlating observed device attributes with evolving PQC standards, the system intelligently pinpoints system vulnerabilities and quantifies readiness as a PQC readiness score, thus offering a real-time, adaptive security tool rather than a mere manual checklist.

In certain implementations, the assessment engine directly communicates with Hardware Security Modules (HSMs), secure key-management servers, and cryptographic accelerators to obtain real-time firmware and algorithm support information. This hardware-level integration involves specialized drivers and APIs capable of retrieving cryptographic metrics—such as supported algorithms and memory usage—necessary for calculating the PQC readiness score. Such automated, in-depth polling of physical devices and firmware statuses far exceeds a typical manual audit. Instead, it provides a computer-implemented method that automatically identifies obsolete cryptographic equipment or end-of-life firmware, thereby enabling practical, technology-driven remediation actions.

The PQC readiness program also addresses the technical need for constant vigilance against newly discovered quantum threats, potential firmware patches, and updated cryptographic standards. Whenever a relevant change occurs—such as an algorithm deprecation by a standards body or a newly disclosed vulnerability—this system can automatically recalculate the PQC readiness score based on fresh inputs from the network's cryptographic devices and policy databases. The system then triggers alerts or notifications, allowing network operators to undertake immediate remediation measures, such as rotating keys to quantum-safe algorithms, upgrading specific network elements, or isolating outdated devices. By automating these tasks and linking real-time data with security actions, the invention improves the operation of networked computer systems and helps prevent quantum-based cryptographic breaches.

As described, the disclosed techniques provide a rigorous, computer-implemented solution for monitoring and securing large-scale network environments. The system's readiness scoring engine draws from specialized data structures—such as tables of cryptographic key parameters, device-compliance matrices, and PQC vulnerability indices—to transform raw hardware and software information into an actionable score. These structures and the associated algorithms enable the PQC readiness program to parse vast amounts of data with minimal manual intervention, furnishing immediate feedback on the quantum-safe status of various network components. Such real-time, automatically updated insights stand in contrast to purely conceptual or spreadsheet-based checklists, delivering a practical technical improvement by reducing computational overhead, mitigating the risk of outdated cryptographic elements, and streamlining the transition to PQC standards.

By employing automated device polling, direct integration with specialized cryptographic hardware, dynamic updating of readiness scores, and recommended remediation actions, the solution improves the functioning of computer networks themselves. The disclosed system's ability to continuously assess hardware readiness and compliance with evolving PQC standards, and then seamlessly present actionable insights to operators, provides a substantial advancement in network security technology.

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A system comprising:
a processing device; and
a memory device configured to store computer logic having instructions that enable the processing device to perform steps of
collecting information with respect to a current state of a network infrastructure associated with an organization, the collected information related to compliance of the network infrastructure with Post-Quantum Cryptography (PQC) standards,
calculating a PQC readiness score from the collected information, and
displaying, on a User Interface (UI), the PQC readiness score and one or more recommended remediation actions for improving the PQC readiness score.

2. The system of claim 1, wherein the network infrastructure includes one or more of Network Elements (NEs), switches, routers, servers, facility security equipment, and organizational cybersecurity policies.

3. The system of claim 1, wherein the computer logic is configured as a PQC readiness program having an assessment engine, a scoring module, and a reporting interface.

4. The system of claim 1, wherein the step of collecting the information includes obtaining and assessing a) cryptographic algorithms in use in the network infrastructure, b) versions of software and firmware in use in the network infrastructure, and c) compliance parameters with respect to the PQC standards or updated PQC standards.

5. The system of claim 1, wherein the step of collecting the information includes one or more of a) gathering data associated with input from a network operator upon execution of an infrastructure survey, and b) automatically gathering data directly from a network domain related to the network infrastructure.

6. The system of claim 1, wherein the instructions further enable the processing device to identify potential vulnerabilities, susceptibilities, or incompatibilities of the network infrastructure to transition to PQC or resist PQC attacks.

7. The system of claim 1, wherein the step of calculating the PQC readiness score includes assigning weights to readiness factors of multiple core dimensions assessed with respect to answers provided by a user in response to survey inquiries.

8. The system of claim 1, wherein the step of calculating the PQC readiness score further includes:
ranking assessment factors into a plurality of categories including a) infrastructure awareness, b) strategy, c) resource allocation, d) cryptographic inventory and management, and e) adaptability, and
computing a sub-score for each category before calculating the PQC readiness score.

9. The system of claim 1, wherein the instructions further enable the processing device to display a visual gauge or meter corresponding to the PQC readiness score.

10. The system of claim 1, wherein the instructions further enable the processing device to store historical PQC readiness scores for the network infrastructure over time and provide indications of improvements in a current PQC readiness score in response to following the one or more recommended remediation actions.

11. The system of claim 1, wherein the instructions further enable the processing device to:
detect ongoing changes to PQC standards and newly discovered vulnerabilities in the network infrastructure, and
trigger notifications or alerts when a decrease in an updated PQC readiness score is detected due to the ongoing changes and newly discovered vulnerabilities.

12. The system of claim 1, wherein the one or more recommended remediation actions include one or more of a) upgrading software and/or firmware versions to support PQC algorithms, b) rotating cryptographic certificates to quantum-safe algorithms, c) establishing or maturing a Crypto Center of Excellence (CCOE), d) implementing parallel PQC certificate chains alongside existing PKI infrastructure, e) decommissioning and/or disposing of legacy cryptographic equipment and policies, f) closing cryptographic policy gaps that hinder a transition to PQC prevention techniques, g) aligning cryptographic policies with emerging PQC standards set forth by NIST, ANSI X9, and other standards groups, h) replacing cryptographic algorithms susceptible to “harvest now, decrypt later” attacks, i) inspect, label, and/or physically secure Hardware Security Modules (HSMs), key-management servers, backup drives, and cryptographic accelerators, j) install or upgrade physical security equipment in data centers associated with the organization, k) decommissioning, segregating, and/or securely disposing of end-of-life hardware and software components, l) install or upgrade redundancy hardware and software or Disaster Recovery (DR) equipment, m) establish or execute test recovery drills and/or attack testing procedures, and n) establish or update personnel screening, testing, and training policies.

13. A method comprising steps of:
collecting information with respect to a current state of a network infrastructure associated with an organization, the collected information related to compliance of the network infrastructure with Post-Quantum Cryptography (PQC) standards;
calculating a PQC readiness score from the collected information; and
displaying, on a User Interface (UI), the PQC readiness score and one or more recommended remediation actions for improving the PQC readiness score.

14. The method of claim 13, wherein the network infrastructure includes one or more of Network Elements (NEs), switches, routers, servers, facility security equipment, and organizational cybersecurity policies.

15. The method of claim 13, wherein the step of collecting the information includes obtaining and assessing a) cryptographic algorithms in use in the network infrastructure, b) versions of software and firmware in use in the network infrastructure, and c) compliance parameters with respect to the PQC standards or updated PQC standards.

16. The method of claim 13, wherein the step of collecting the information includes one or more of a) gathering data associated with input from a network operator upon execution of an infrastructure survey, and b) automatically gathering data directly from a network domain related to the network infrastructure.

17. The method of claim 13, further comprising a step of identifying potential vulnerabilities, susceptibilities, or incompatibilities of the network infrastructure to transition to PQC or resist PQC attacks.

18. The method of claim 13, wherein the step of calculating the PQC readiness score includes assigning weights to readiness factors of multiple core dimensions assessed with respect to answers provided by a user in response to survey inquiries.

19. A non-transitory computer-readable medium configured to store computing logic having instructions that enable a processing device to:
collect information with respect to a current state of a network infrastructure associated with an organization, the collected information related to compliance of the network infrastructure with Post-Quantum Cryptography (PQC) standards,
calculate a PQC readiness score from the collected information, and
display, on a User Interface (UI), the PQC readiness score and one or more recommended remediation actions for improving the PQC readiness score.

20. The non-transitory computer-readable medium of claim 19, wherein the instructions further enable the processing device to store historical PQC readiness scores for the network infrastructure over time and provide indications of improvements in a current PQC readiness score in response to following the one or more recommended remediation actions.
